(19) United States
(12) Patent Application Publication
(10) Pub. No.: US 2023/0395047 A1
(43) Pub. Date: Dec. 7, 2023

(54) AUDIO ANALYSIS METHOD, AUDIO ANALYSIS SYSTEM AND PROGRAM

(71) Applicant: Yamaha Corporation, Hamamatsu, Shizuoka (JP)

(72) Inventor: Kazuhiko YAMAMOTO, Hamamatsu, Shizuoka (JP)

(21) Appl. No.: 18/453,196

(22) Filed: Aug. 21, 2023

Related U.S. Application Data
(63) Continuation of application No. PCT/JP2022/006612, filed on Feb. 18, 2022.

(30) Foreign Application Priority Data
Feb. 25, 2021 (JP) 2021-028539
Feb. 25, 2021 (JP) 2021-028549

(51) Int. Cl. G10H 1/00

(52) U.S. Cl. CPC G10H 1/0008; G10H 2210/076; G10H 2220/101; G10H 2210/381

(57) ABSTRACT

An audio analysis method that is realized by a computer system includes setting a maximum tempo curve representing a temporal change of a maximum tempo value and a minimum tempo curve representing a temporal change of a minimum tempo value in accordance with an instruction from a user, and analyzing an audio signal representing a performance sound of a musical piece, thereby estimating a tempo of the musical piece within a restricted range between a maximum value represented by the maximum tempo curve and a minimum value represented by the minimum tempo curve.

### CROSS-REFERENCE TO RELATED APPLICATIONS

This application is a continuation application of International Application No. PCT/JP2022/006612, filed on Feb. 18, 2022, which claims priority to Japanese Patent Application No. 2021-028539 filed in Japan on Feb. 25, 2021 and Japanese Patent Application No. 2021-028549 filed in Japan on Feb. 25, 2021. The entire disclosures of International Application No. PCT/JP2022/006612 and Japanese Patent Application Nos. 2021-028539 and 2021-028549 are hereby incorporated herein by reference.

### BACKGROUND

### Technological Field

This disclosure relates to a technology for analyzing audio signals.

### Background Information

Analysis techniques for estimating tempo (performance speed) of a musical piece by analyzing audio signals that represent the sound of the performed musical piece have been proposed in the prior art. For example, Japanese Laid-Open Patent Application No. 2015-114361 discloses a technology for estimating the beat points and tempo of a musical piece by using a stochastic model such as a hidden Markov model.

### SUMMARY

However, in the prior art for estimating the tempo of a musical piece, there are cases in which tempo that is twice or half of the actual tempo of the musical piece is incorrectly estimated. Given the circumstance described above, an object of this disclosure is to estimate accurately the tempo of a musical piece represented by an audio signal.

In order to solve the problem described above, an audio analysis system according to one aspect of this disclosure comprises setting a maximum tempo curve representing a temporal change of a maximum tempo value, and a minimum tempo curve representing a temporal change of a minimum tempo value in accordance with an instruction from a user, and analyzing an audio signal representing a performance sound of a musical piece, thereby estimating a tempo of the musical piece within a restricted range between the maximum value represented by the maximum tempo curve and the minimum value represented by the minimum tempo curve.

An audio analysis system according to one aspect of this disclosure comprises an electronic controller including at least one processor. The electronic controller is configured to execute a curve setting unit configured to set a maximum tempo curve representing a temporal change of a maximum tempo value and a minimum tempo curve representing a temporal change of a minimum tempo value in accordance with an instruction from a user, and an analysis processing unit configured to analyze an audio signal representing a performance sound of a musical piece to estimate a tempo of the musical piece within a restricted range between a maximum value represented by the maximum tempo curve and a minimum value represented by the minimum tempo curve.

A non-transitory computer-readable medium storing a program according to one aspect of this disclosure causes a computer system to execute a process comprising: setting a maximum tempo curve representing a temporal change of a maximum tempo value and a minimum tempo curve representing a temporal change of a minimum tempo value, in accordance with an instruction from the user, and analyzing an audio signal representing a performance sound of a musical piece, thereby estimating a tempo of the musical piece within a restricted range between the maximum value represented by the maximum tempo curve and the minimum value represented by the minimum tempo curve.

### BRIEF DESCRIPTION OF THE DRAWINGS

FIG. 1 is a block diagram illustrating the configuration of an audio analysis system according to a first embodiment.

FIG. 2 is a block diagram illustrating the functional configuration of the audio analysis system.

FIG. 3 is an explanatory illustration of an operation in which a feature extraction unit generates feature data.

FIG. 4 is a block diagram illustrating the configuration of an estimation model.

FIG. 5 is a block diagram illustrating the machine learning process used to establish an estimation model.

FIG. 6 is a flowchart illustrating the specific steps in a probability calculation process.

FIG. 7 is an explanatory illustration of a state transition model.

FIG. 8 is an explanatory illustration of a beat point estimation process.

FIG. 9 is a flowchart illustrating the specific steps of the beat point estimation process.

FIG. 10 is a schematized diagram of an analysis screen.

FIG. 11 is a block diagram illustrating an estimation model update process.

FIG. 12 is a flowchart illustrating the specific steps of an estimation model update process.

FIG. 13 is a flowchart illustrating the specific steps of a process executed by a control device.

FIG. 14 is a flowchart illustrating the specific steps of an initial analysis process.

FIG. 15 is a flowchart illustrating the specific steps of a beat point update process.

FIG. 16 is a block diagram illustrating the functional configuration of an audio analysis system according to a second embodiment.

FIG. 17 is a schematized diagram of an analysis screen according to the second embodiment.

FIG. 18 is an explanatory diagram of an estimated tempo curve, a maximum tempo curve, and a minimum tempo curve.

FIG. 19 is a flowchart illustrating the specific steps of the beat point estimation process of the second embodiment.

FIG. 20 is an explanatory diagram of a process for generating output data in a third embodiment.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

### A: First Embodiment

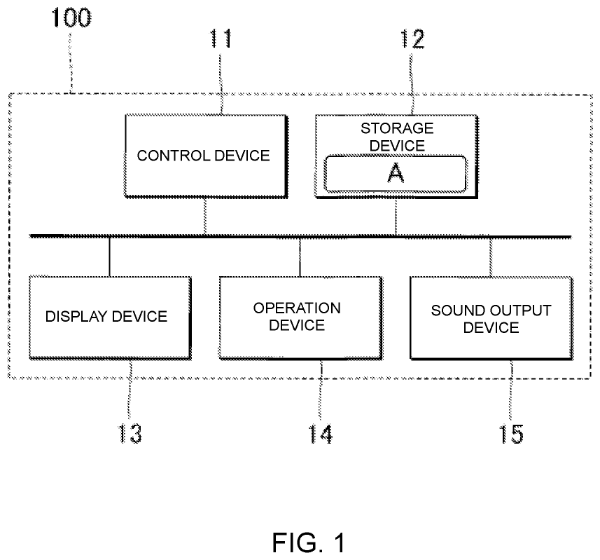

FIG. 1 is a block diagram illustrating the configuration of an audio analysis system 100 according to a first embodiment. The audio analysis system 100 is a computer system for estimating a plurality of beat points in a musical piece by an analyzing an audio signal A representing the performance sound of the musical piece. The audio analysis system 100 comprises a control device 11, a storage device 12, a display device 13, an operation device 14, and a sound output device 15. The audio analysis system 100 is realized by a portable information device such as a smartphone or a tablet terminal, or a portable or stationary information device such as a personal computer. The audio analysis system 100 can be realized as a single device or as a plurality of devices which are separately configured.

The control device 11 is an electronic controller that includes one or more processors that control each element of the audio analysis system 100. For example, the control device 11 is configured to comprise one or more types of processors, such as a CPU (Central Processing Unit), an SPU (Sound Processing Unit), a DSP (Digital Signal Processor), an FPGA (Field Programmable Gate Array), an ASIC (Application Specific Integrated Circuit), etc. Here, the term “electronic controller” as used herein refers to hardware, and does not include a human.

The storage device 12 includes one or more computer memories or memory units for storing a program that is executed by the control device 11 and various data that are used by the control device 11. The storage device 12 comprises a known storage medium, such as a magnetic storage medium or a semiconductor storage medium, or a combination of a plurality of various types of storage media. A portable storage medium that can be attached to or detached from the audio analysis system 100 or a storage medium (for example, cloud storage) that the control device 11 can read from or write to via a communication network such as the Internet can also be used as the storage device 12. The storage device 12 is one example of a non-transitory storage medium.

The storage device 12 stores the audio signal A. The audio signal A is a sampled sequence representing the waveform of performance sounds of a musical piece. Specifically, the audio signal A represents instrument sounds and/or singing sounds of a musical piece. The data format of the audio signal A is arbitrary. The audio signal A can be supplied to the audio analysis system 100 from a signal supply device that is separate from the audio analysis system 100. The signal supply device is, for example, a reproduction device that supplies the audio signal A stored on a storage medium to the audio analysis system 100, or a communication device that supplies the audio signal A received from a distribution device (not shown) via a communication network to the audio analysis system 100.

The display device 13 (display) displays images under the control of the control device 11. For example, various display panels such as a liquid-crystal display panel or an organic EL (Electroluminescence) display panel are used as the display device 13. The display device 13, which is separate from the audio analysis system 100, can be connected to the audio analysis system 100 wirelessly or by wire. The operation device 14 is an input device (user operable input(s)) that receives instructions from a user. For example, the operation device 14 is a controller operated by the user, or a touch panel that detects contact from the user.

The sound output device 15 reproduces sound under the control of the control device 11. For example, a speaker or headphones are used as the sound output device 15. A sound output device 15 that is separate from the audio analysis system 100 can be connected to the audio analysis system 100 wirelessly or by wire.

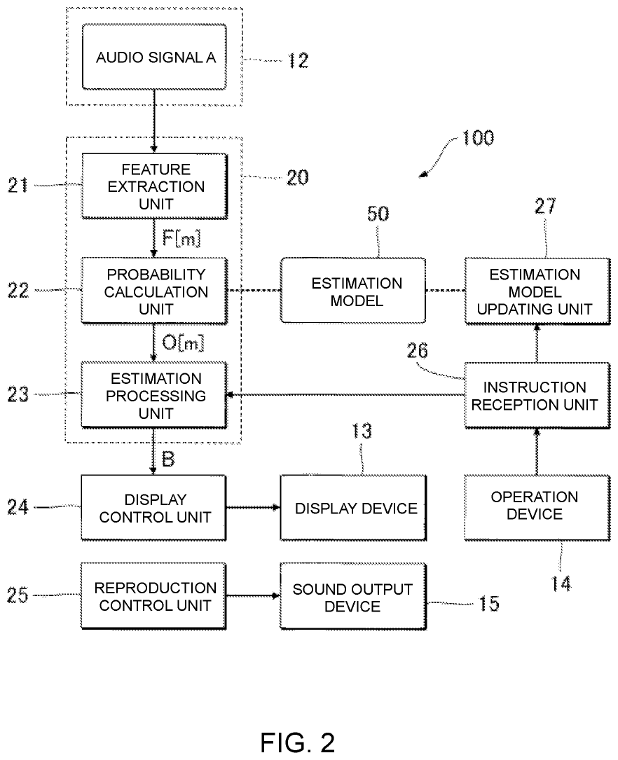

FIG. 2 is a block diagram illustrating the functional configuration of the audio analysis system 100. The control device 11 executes a program stored in the storage device 12 to realize a plurality of functions (analysis processing unit 20, display control unit 24, reproduction control unit 25, instruction receiving unit 26, and estimation model updating unit 27) for processing the audio signal A.

The analysis processing unit 20 estimates a plurality of beat points in a musical piece by analyzing the audio signal A. More specifically, the analysis processing unit 20 generates beat point data B from the audio signal A. The beat point data B are data that represent each beat point in a musical piece. More specifically, the beat point data B are time-series data that specify the time of each of the plurality of beat points in a musical piece. For example, the time of each beat point with respect to the starting point of the audio signal A is specified by beat point data B. The analysis processing unit 20 of the first embodiment includes a feature extraction unit 21, a probability calculation unit 22, and an estimation processing unit 23.

### Feature Extraction Unit 21

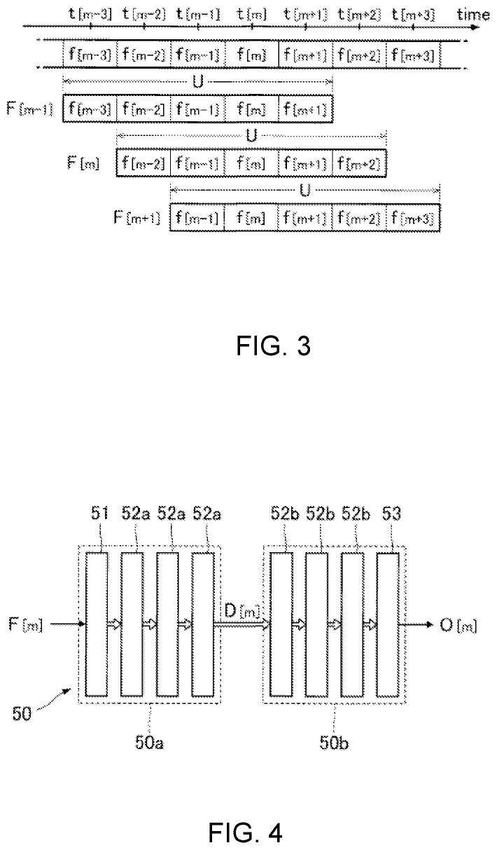

FIG. 3 is an explanatory illustration of the operation of the feature extraction unit 21. The feature extraction unit 21 generates a feature value f[m] (m=1 M) of the audio signal A for each of the M time points t[m] on the time axis (hereinafter referred to as “analysis time points”). Here, M is a positive number. Each analysis time point t[m] is a time point set on the time axis at prescribed intervals. The feature value f[m] is an index representing acoustic features of the audio signal A. Specifically, a feature value f[m] that tends to vary significantly before and after a beat point is used. For example, information pertaining to the intensity of the audio signal A, such as volume and amplitude, is an example of a feature value f[m]. In addition, information pertaining to the frequency characteristics (timbre) of the audio signal A, such as MFCC (Mel-Frequency Cepstrum Coefficients), MSLS (Mel-Scale Log Spectrum), or CQT (Constant-Q Transform), can be used as the feature value f[m]. However, the types of feature values f[m] are not limited to the examples described above. The feature value f[m] can be a combination of a plurality of types of information pertaining to the audio signal A.

The feature extraction unit 21 generates feature data F[m] for each analysis time point t[m]. The feature data F[m] corresponding to a given analysis time point t[m] are a time series of a plurality of feature values f[m] within a period of time U (hereinafter referred to as “unit period”) that includes the analysis time point t[m]. FIG. 3 shows an example in which one unit period U includes five analysis time points t[m−2]˜t[m+2] centered on the mth analysis time point t[m]. Therefore, the feature data F[m] are a time series of five feature values f[m−2]˜f[m+2] within the unit period U. It should be noted that unit period U can include only one analysis time point [m]. That is, the feature data F[m] can consist of only one feature value f[m]. As can be understood from the foregoing explanation, the feature extraction unit 21 generates the feature data F[m] including the feature value f[m] of the audio signal A for each analysis time point t[m].

Probability calculation unit 22.

The probability calculation unit 22 of FIG. 2 generates output data O[m] representing the probability P[m] that each analysis time point t[m] corresponds to a beat point of the musical piece from the feature data F[m]. The generation of the output data O[m] is iterated for each analysis time point t[m]. The greater the probability P[m], the higher the likelihood that the analysis time point t[m] will correspond to a beat point. An estimation model 50 is used for the generation of the output data O[m] by the probability calculation unit 22.

There is a correlation between the feature data F[m] at each analysis time point t[m] of the audio signal A and the likelihood that the analysis time point t[m] corresponds to a beat point. The estimation model 50 is a statistical model that has learned the above-described correlation. Specifically, the estimation model 50 is a learned model that has learned the relationship between the feature data F[m] and the output data O[m] by machine learning.

The estimation model 50 comprises a deep neural network (DNN), for example. The estimation model 50 is realized by a combination of a program that causes the control device 11 to execute a calculation for generating the output data O[m] from the feature data F[m] and a plurality of variables (specifically, weighted values and biases) that are applied to the calculation. The program and the plurality of variables that realize the estimation model 50 are stored in the storage device 12. The numerical values of each of the plurality of variables defining the estimation model 50 are set in advance by machine learning.

FIG. 4 is a block diagram illustrating the specific configuration of the estimation model 50. The estimation model 50 is composed of a convolutional neural network that includes an input layer 51, a plurality of intermediate layers 52 (52a, 52b), and an output layer 53. The plurality of feature values f[m−2]˜f[m+2] included in one piece of feature data F[m] are input to the input layer 51 in parallel.

The plurality of intermediate layers 52 are hidden layers located between the input layer 51 and the output layer 53. The plurality of intermediate layers 52 include a plurality of intermediate layers 52a and a plurality of intermediate layers 52b. The plurality of intermediate layers 52a are located between the input layer 51 and the plurality of intermediate layers 52b. Each of the intermediate layers 52a is composed of a combination of a convolutional layer and a pooling layer, for example. Each of the intermediate layers 52b is a fully-connected layer with, for example, ReLU as the activation function. The output layer 53 outputs the output data O[m].

The estimation model 50 is divided into a first part 50a and a second part 50b. The first part 50a is the part of the estimation model 50 on the input side. Specifically, the first part 50a is the first half of the model composed of the input layer 51 and the plurality of intermediate layers 52a. The second part 50b is the part of the estimation model 50 on the output side. Specifically, the second part 50b is the second half of the model composed of the output layer 53 and the plurality of intermediate layers 52b. The first part 50a is the part that generates intermediate data D[m] according to the feature data F[m]. The intermediate data D[m] are data representing the features of the feature data F[m]. Specifically, the intermediate data D[m] are data representing features that contribute to outputting statistically valid output data O[m] with respect to the feature data F[m]. The second part 50b is the part that generates output data O[m] according to the intermediate data D[m].

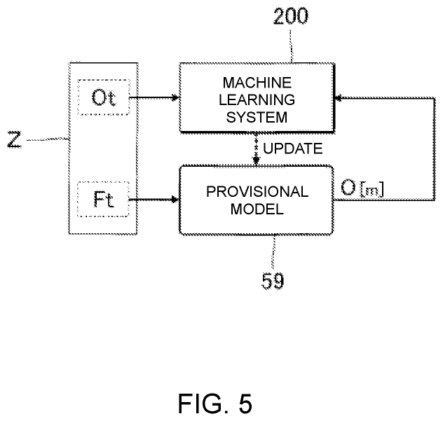

FIG. 5 is a block diagram illustrating the machine learning process used to establish the estimation model 50. For example, the estimation model 50 is established by machine learning by a machine learning system 200 that is separate from the audio analysis system 100, and the estimation model 50 is provided to the audio analysis system 100. For example, the estimation model 50 is transmitted from the machine learning system 200 to the audio analysis system 100.

A plurality of training data Z is used for the machine learning of the estimation model 50. Each of the plurality of pieces of training data Z is composed of a combination of feature data Ft for training and output data Ot for training. The feature data Ft represent the feature values of the audio signal A prepared for learning at specific points in time. Specifically, the feature data Ft is composed of a time series of a plurality of feature values corresponding to different time points on the time axis, similar to the above-mentioned feature data F[m]. The output data Ot for training corresponding to a specific point in time are data representing the probability that the time point corresponds to a beat point of the musical piece (that is, the correct answer value). A plurality of training data Z are prepared for a large number of known musical pieces.

The machine learning system 200 calculates an error function representing the error between the output data O[m] output by an initial or provisional model (hereinafter referred to as “provisional model”) 59 when the feature data Ft of the training data Z are input, and the output data Ot of the training data Z. The machine learning system 200 then updates the plurality of variables of the provisional model 59 such that the error function is reduced. The provisional model 59 at the point in time when the above-described process is iterated for each of the plurality of training data Z is set as the estimation model 50.

Thus, the estimation model 50 outputs statistically valid output data O[m] for unknown feature data F[m] under the potential relationship between the feature data Ft and the output data Ot in the plurality of training data Z. That is, the estimation model 50 is a learned model that has learned the relationship between the feature data Ft for training corresponding to each time point on the time axis and the output data Ot for training that represents the probability that the time point corresponds to a beat point. The probability calculation unit 22 inputs the feature data F[m] of each analysis time point t[m] into the estimation model 50 established by the procedure described above, thereby generating the output data O[m] representing the probability P[m] that the analysis time point t[m] corresponds to a beat point.

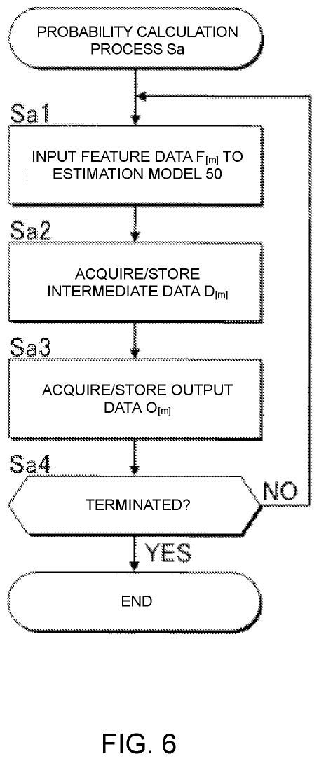

FIG. 6 is a flowchart illustrating the specific procedure of a process Sa executed by the probability calculation unit 22 (hereinafter referred to as the “probability calculation process”). The control device 11 functions as the probability calculation unit 22 to execute the probability calculation process Sa.

When the probability calculation process Sa is started, the probability calculation unit 22 inputs the feature data F[m] corresponding to the analysis time point t[m] into the estimation model 50 (Sa1). The probability calculation unit 22 acquires the intermediate data D[m] output by the first part 50a of the estimation model 50 and stores the intermediate data D[m] in the storage device 12 (Sa2). In addition, the probability calculation unit 22 acquires the output data O[m] output by the estimation model 50 (second part 50b) and stores the output data O[m] in the storage device 12 (Sa3).

The probability calculation unit 22 determines whether the process described above has been executed for M analysis time points t[1]˜t[M] in the musical piece (Sa4). If the determination result is negative (Sa4: NO), the probability calculation unit 22 generates the intermediate data D[m] and the output data O[m] (Sa1˜Sa3) for the unprocessed analysis time points t[m]. The probability calculation unit 22 terminates the probability calculation process Sa once the process has been executed for M analysis time points t[1] t[M] (Sa4: YES). As can be understood from the foregoing explanation, as a result of the probability calculation process Sa, M pieces of intermediate data D[1]˜D[M] corresponding to different analysis time points t[m], and M pieces of output data O[1]˜O[M] corresponding to different analysis time points t[m] are stored in the storage device 12. Estimation processing unit 23.

The estimation processing unit 23 in FIG. 2 estimates a plurality of beat points in the musical piece from the M pieces of output data O[m] calculated by the probability calculation unit 22 for different analysis time points t[m]. Specifically, as described above, the estimation processing unit 23 generates beat point data B representing the time of each beat point in the musical piece. A state transition model 60 is used for the generation of the beat point data B by the probability calculation unit 22.

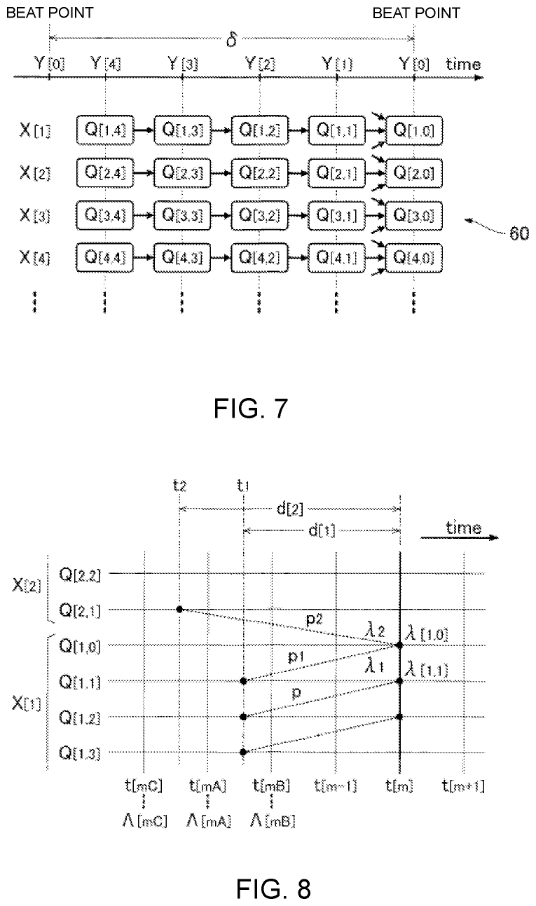

FIG. 7 is an explanatory illustration of the configuration of the state transition model 60. The state transition model 60 is a statistical model consisting of a plurality (N) of states Q. Here, N is a positive number. Specifically, the state transition model 60 comprises a hidden semi-Markov model (HSMM), and plurality of beat points are estimated by a Viterbi algorithm, which is an example of dynamic programming.

FIG. 7 illustrates the beat points on the time axis. The length of time of the interval δ between two consecutive beat points on the time axis (hereinafter referred to as the “beat interval”) is a variable value that depends on the tempo of the musical piece. Specifically, the faster the tempo, the shorter the beat interval δ. A plurality of time points (hereinafter referred to as “transition points”) Y[j] are set within the beat interval δ. Each transition point Y[i] (i=1˜4) is a time point set on the time axis based on a beat point. Specifically, a transition point Y[0] is a time point (lead position of a beat) corresponding to a beat point, and transition points Y[1]˜Y[4] are time points that divide the beat interval δ into equal parts. Transition point Y[3] is located behind transition point Y[4], transition point Y[2] is located behind transition point Y[3], and transition point Y[1] is located behind transition point Y[2]. Transition point Y[0] corresponds to an end point (starting point or end point) of a beat interval δ. The length of time from each beat point (transition point Y[0]) to each transition point Y can be expressed as the phase based on the beat point. For example, time progresses in the order of transition point Y[4]→transition point Y[3]→transition point Y[2]→transition point Y[1], and, after having passed through transition point Y[1], transition point Y[0] (beat point) is reached.

Each of the N states Q of the state transition model 60 corresponds to one of a plurality of tempos X[i] (i=1, 2, 3, . . . ). Specifically, each of the N states Q corresponds to a different combination of each of the plurality of tempos X[i] and each of the plurality of transition points Y[0]˜Y[4]. That is, for each tempo X[i], there is a time series of five states Q corresponding to different transition points Y[j]. In the following description, the state Q that corresponds to the combination of a tempo X[i] and a transition point Y[j] can be expressed as “state Q[i, j].” On the other hand, when no particular attention is paid to the distinction between the tempo X[i] and the transition point Y[j], it is simply denoted as “state Q.” The distinction of the state Q by the transition point Y[j] can be omitted. That is, an implementation in which each of a plurality of states Q corresponds to a different tempo X[i] is conceivable. In an implementation in which the transition point Y[j] is not distinguished, for example, a hidden Markov model (HMM) is used as the state transition model 60.

In the first embodiment, it is assumed that the tempo X changes only at the beat points (that is, transition point Y[0]) on the time axis. Under the assumption described above, state Q[i, j] corresponding to each transition point Y[j] other than transition point Y[0] transitions only to state Q[i, j−1] corresponding to the immediately following transition point Y[j−1]. For example, state Q[i, 4] transitions to state Q[i, 3], state Q[i, 3] transitions to state Q[i, 2], and state Q[i, 2] transitions to state Q[i, 1]. On the other hand, state Q[i, 0] which corresponds to the beat points, will have transitions from a plurality of states Q[i, 1] (Q[1, 1], Q[2, 1], Q[3, 1], . . . ) corresponding to different tempos X[i].

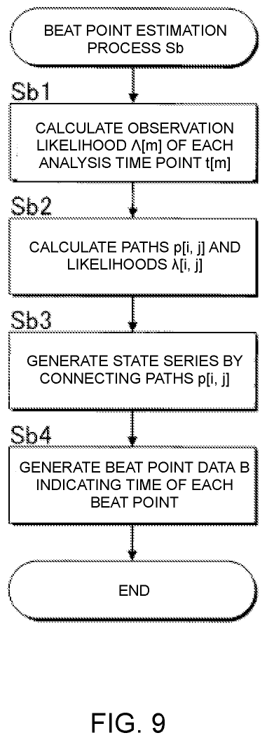

FIG. 8 is an explanatory illustration of a process (hereinafter referred to as the “beat point estimation process”) Sb in which the estimation processing unit 23 uses the state transition model 60 to estimate a plurality of beat points within a musical piece. In addition, FIG. 9 is a flowchart illustrating the specific procedure of the beat point estimation process Sb. The control device 11 functions as the estimation processing unit 23 to execute the beat point estimation process Sb.

When the beat point estimation process Sb is started, the estimation processing unit 23 calculates an observation likelihood Λ[m] for each of the M analysis time points t[1]˜t[M] (Sb1). The observation likelihood Λ[m] for each analysis time point t[m] is set to a numerical value corresponding to the probability P[m] represented by the output data O[m] of the analysis time point t[m]. For example, the observation likelihood Λ[m] is set to the probability P[m] represented by the output data O[m] or to a numerical value calculated by a prescribed computation performed on the probability P[m].

The estimation processing unit 23 calculates a path p[i, j] and likelihood λ[i, j] for each analysis time point t[m] for each state Q [i, j] of the state transition model 60. The path p[i, j] is a path from another state Q to the state Q[i, j], and the likelihood λ[i, j] is an index of the probability that the state Q[i, j] is observed.

As described above, only unidirectional transitions occur between plural states Q[i, 0]˜Q[i, 4] corresponding to any given tempo X[i]. Therefore, as can be understood from FIG. 8, the only path p[1, 1] for arriving at state Q[1, 1] corresponding to tempo X[1] and transition point Y[1] at analysis time point t[m] is the path p from state Q[1, 2] corresponding to the tempo X[1] and the immediately preceding transition point Y[2]. In addition, the likelihood λ[1, 1] of state Q[1, 1] at analysis time point t[m] is set to the likelihood that corresponds to time point t1, which precedes analysis time point t[m] by a time length d[1] corresponding to the tempo X[1]. Specifically, the likelihood λ[1, 1] of state Q[1, 1] is calculated by interpolation (for example, linear interpolation) between the observed likelihood Λ[mA] at analysis time point t[mA] immediately preceding time t1 and the observed likelihood Λ[mB] at analysis time point t[mB] immediately following the time point t1.

On the other hand, tempo X[i] can change at transition point Y[0]. Therefore, as can be understood from FIG. 8, separate paths p reach state Q[1, 0], corresponding to tempo X[1] and transition point Y[0] from each of a plurality of states Q[i, 1] corresponding to different tempos X[i]. For example, in addition to a path p1 from state Q[1, 1] corresponding to a combination of the tempo X[1] and the immediately preceding transition point Y[1], a path p2 from state Q[2, 1] corresponding to a combination of tempo X[2] and the immediately preceding transition point Y[1] also arrives at the state Q[1, 0]. As in the previous example, the likelihood λ1 of path p1 from state Q[1, 1] to state Q[1, 0] is calculated by interpolation (for example, linear interpolation) between the observed likelihood Λ[mA] at analysis time point t[mA] immediately preceding time t1, and the observed likelihood Λ[mB] at analysis time point t[mB] immediately following the time point t1. In addition, a likelihood λ2 for path p2 from state Q[2, 1] to the state Q[1, 0] is set to the likelihood at time point t2 that precedes analysis time point t[m] by time length d[2] corresponding to tempo X[2] of the state Q[2, 1]. Specifically, the likelihood λ2 is calculated by interpolation (for example, linear interpolation) between the observed likelihood Λ[mC] at analysis time point t[mC] immediately preceding time t2 and the observed likelihood Λ[mA] at analysis time point t[mA] immediately following the time point t2. The estimation processing unit 23 selects the maximum value of a plurality of likelihoods λ (λ1, λ2, . . . ) calculated for different tempos X[i] as the likelihood λ[1, 0] of state Q[1, 0] at analysis time point t[m] and sets the path p corresponding to the likelihood λ[1, 0], from among a plurality of paths p (p1, p2, . . . ) that reach the state Q[1, 0] as the path p [1,0] to the state Q[1, 0]. The process of calculating the path p[i, j] and the likelihood λ[i, j] for each of N states Q is performed for each analysis time point t[m] along the forward direction of the time axis by the procedure described above. That is, the path p[i, j] and likelihood λ[i, j] of each state Q are calculated for each of the M analysis time points t[1]˜t[M].

The estimation processing unit 23 generates a time series of M states Q (hereinafter referred to as “state series”) corresponding to different analysis time points t[m] (Sb3). Specifically, the estimation processing unit 23 connects paths p[i, j] from state Q[i, j] corresponding to the maximum value of N likelihoods λ[i, j] calculated for the last analysis time point t[M] of the musical piece in sequence along the reverse direction of the time axis and generates a state series from M states Q located on the series of connected paths (that is, the maximum likelihood path). That is, a state series is generated by arranging the states Q having the greatest likelihoods λ[i, j] among the N states Q at each analysis time point t[m].

The estimation processing unit 23 estimates, as a beat point, each analysis time point t[m] at which state Q corresponding to the transition point Y[0] is observed among the M states Q that constitute the state series and generates the beat point data B that specify the time of each beat point (Sb4). As can be understood from the foregoing explanation, analysis time points t[m] at which probability P[m] represented by output data O[m] is high and at which there is an acoustically natural transition of the tempo are estimated as beat points in the musical piece.

As described above, in the first embodiment, the output data O[m] for each analysis time point t[m] are generated by inputting feature data F[m] for each analysis time point t[m] into the estimation model 50, and a plurality of beat points are estimated from the output data O[m]. Therefore, statistically valid output data O[m] can be generated for unknown feature data F[m] under the potential relationship between output data Ot for training and feature data Ft for training. The foregoing is a specific example of the configuration of the analysis processing unit 20.

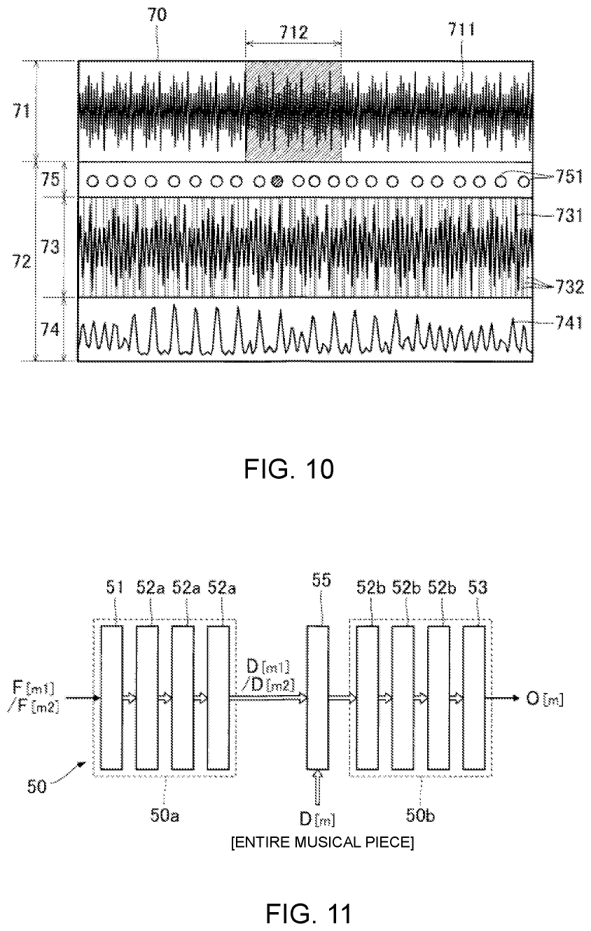

The display control unit 24 of FIG. 2 causes the display device 13 to display an image. Specifically, the display control unit 24 causes the display device 13 to display the analysis screen 70 shown in FIG. 10. The analysis screen 70 is an image representing the result of the analysis of the audio signal A by the analysis processing unit 20.

The analysis screen 70 includes a first region 71 and a second region 72. The first region 71 displays a waveform 711 of the audio signal A. The second region 72 displays the results of an analysis of a portion 712 of the period specified in the first region 71 (hereinafter referred to as “specified period”) of the audio signal A. The second region 72 includes a waveform region 73, a probability region 74, and a beat point region 75.

A common time axis is set for the waveform region 73, the probability region 74, and the beat point region 75. The waveform region 73 displays a waveform 731 of the audio signal A within the specified period 712 and sound generation points (onset) 732 in the audio signal A. The probability region 74 displays a time series 741 of the probabilities P[m] represented by the output data O[m] of each analysis time point t[m]. The time series 741 of probabilities P[m] represented by the output data O[m] can be displayed within the waveform area 73 superimposed on the waveform 731 of the audio signal A.

A plurality of beat points in the musical piece estimated by analyzing the audio signal A is displayed in the beat point region 75. Specifically, a time series of a plurality of beat images 751 corresponding to different beat points in the musical piece is displayed in the beat point region 75. Of the plurality of beat points in the musical piece, one or more beat images 751 corresponding to one or more beat points that satisfy a prescribed condition (hereinafter referred to as “correction candidate points”) are highlighted in a different display mode than the other beat images 751. The correction candidate points are beat points that the user is likely to issue an instruction for change.

The reproduction control unit 25 of FIG. 2 controls the reproduction of sounds by the sound output device 15. Specifically, the reproduction control unit 25 causes the sound output device 15 to reproduce performance sound represented by the audio signal A. The reproduction control unit 25 reproduces a prescribed notification sound at time points corresponding to each of a plurality of beat points in parallel with the reproduction of the audio signal A. In addition, the display control unit 24 highlights one of the beat images 751, which corresponds to the time point being reproduced by the sound output device 15, from among the plurality of beat images 751 within the beat point region 75, in a display mode different from the other beat images 751 in the beat point region 75. That is, each of the plurality of beat images 751 is highlighted sequentially in chronological order in parallel with the reproduction of the audio signal A.

It should be noted that in the process of estimating a plurality of beat points in a musical piece from the audio signal A, there is a possibility that, for example, upbeats of the musical piece are incorrectly estimated as beat points. There is also the possibility that the result of estimating beat points does not conform to the intention of the user, such as is the case when the upbeats of a musical piece are estimated in a situation in which the user is expecting the downbeats to be estimated. The user can operate the operation device 14 to issue an instruction to change one or more location(s) on the time axis of any beat point(s) of the plurality of beat points in the musical piece. Specifically, by moving any one of the plurality of beat images 751 within the beat point region 75 in the time axis direction, the user issues an instruction to change the location of the beat point corresponding to the beat image 751. For example, the user issues an instruction to change the location of the correction candidate point from among the plurality of beat points.

The instruction receiving unit 26 shown in FIG. 2 receives an instruction from the user to change one or more locations of a part of the beat points among the plurality of beat points in the musical piece (hereinafter referred to as a “change instruction”). In the following description, it is assumed that the instruction receiving unit 26 receives a change instruction to move one beat point from analysis time point t[m1] to analysis time point t[m2] on the time axis (where m1, m2=1˜M, m1≠m2). The analysis time point t[m1] is a beat point that the analysis processing unit 20 initially estimated (that is, the beat point before the change due to the change instruction), and the analysis time point t[m2] is the beat point after the change due to the change instruction from the user.

The estimation model updating unit 27 in FIG. 2 updates the estimation model in accordance with the change instruction from the user. Specifically, the estimation model updating unit 27 updates the estimation model 50 such that the change in beat point(s) according to the change instruction is reflected in the estimation of the plurality of beat points throughout the entire musical piece.

FIG. 11 is a block diagram illustrating a process Sc in which the estimation model updating unit 27 updates the estimation model 50 (hereinafter referred to as the “estimation model updating process”). The estimation model updating process Sc is a process (additional training) for updating the estimation model 50 that has already learned in the machine learning system 200 to reflect the change instruction from the user.

In the estimation model updating process Sc, an adaptation block 55 is added between the first part 50a and the second part 50b of the estimation model 50. The adaptation block 55 comprises, for example, an attention in which the activation function has been initialized to an identity function. Therefore, the initial adaptation block 55 supplies intermediate data D[m] output from the first part 50a to the second part 50b without change.

The estimation model updating unit 27 sequentially inputs feature data F[m1] at analysis time point t[m1] where the beat point before the change is located and feature data F[m2] at analysis time point t[m2] where the beat point after the change is located to the first part 50a (input layer 51). The first part 50a generates intermediate data D[m1] corresponding to feature data F[m1] and intermediate data D[m2] corresponding to feature data F[m2]. Each piece of intermediate data D[m1] and intermediate data D[m2] is sequentially input to the adaptation block 55.

The estimation model updating unit 27 also sequentially provides each of the M pieces of intermediate data D[1]˜D[M] calculated in the immediately preceding probability calculation process Sa (Sa2) to the adaptation block 55. That is, intermediate data D[m] (D[m1], D[m2]) corresponding to some of the analysis time points t[m] among the M analysis time points t[1]˜t[M] in the musical piece pertaining to the change instruction and M pieces of intermediate data D[1]˜D[M] throughout the entire musical piece are input to the adaptation block 55. The adaptation block 55 calculates the degree of similarity between the intermediate data D[m] (D[m1], D[m2]) corresponding to the analysis time points t[m] pertaining to the change instruction and the intermediate data D[m] supplied from the estimation model updating unit 27.

As described above, the analysis time point t[m2] is a time point that was estimated not to correspond to a beat point in the immediately preceding probability calculation process Sa, but that was instructed to be a beat point because of the change instruction. That is, the probability P[m2] represented by the output data O[m2] of the analysis time point t[m2] is set to a small numerical value in the immediately preceding probability calculation process Sa but should be set to a numerical value close to 1 under the change instruction from the user. Further, not only for analysis time point t[m2], but also for each analysis time point t[m] in which intermediate data D[m] that are similar to the intermediate data D[m2] of the analysis time point t[m2] are observed among the M analysis time points t[1]˜t[M] in the musical piece, the probability P[m] represented by output data O[m] of analysis time point t[m] should also be set to a numerical value close to 1. Thus, the estimation model updating unit 27 updates the plurality of variables of the estimation model so that the probability P[m] of output data O[m] approaches a sufficiently large numerical value (for example, 1) when the degree of similarity between intermediate data D[m] and intermediate data D[m2] exceeds a prescribed threshold value. Specifically, the estimation model updating unit 27 updates the coefficients that define each of the first part 50a, the adaptation block 55, and the second part 50b, so that the error between probability P[m] of output data O[m] generated by the estimation model 50 from each piece of intermediate data D[m], whose degree of similarity to intermediate data D[m2] exceeds the threshold value, and the numerical value indicating a beat point (i.e., 1) is reduced.

On the other hand, the analysis time point t[m1] is a time point that was estimated to correspond to a beat point in the immediately preceding probability calculation process Sa, but that was instructed not to correspond to a beat point due to the change instruction. That is, probability P[m1] represented by output data O[m1] of analysis time point t[m1] is set to a large numerical value in the immediately preceding probability calculation process Sa but should be set to a numerical value close to zero under the change instruction from the user. Further, not only for analysis time point t[m1], but also for each analysis time point t[m] in which intermediate data D[m] that are similar to intermediate data D[m1] of the analysis time point t[m1] are observed among the M analysis time points t[1] t[M] in the musical piece, the probability P[m] represented by output data O[m] of the analysis time point t[m] should also be set to a numerical value close to zero. Thus, the estimation model updating unit 27 updates the plurality of variables of the estimation model 50 so that probability P[m] of output data O[m] approaches a sufficiently small numerical value (for example, zero) when the degree of similarity between intermediate data D[m] and intermediate data D[m1] exceeds a prescribed threshold value. Specifically, the estimation model updating unit 27 updates the coefficients that define each of the first part 50a, the adaptation block 55, and the second part 50b, so that the error between the probability P[m] of output data O[m] generated by the estimation model 50 from each piece of the intermediate data D[m], whose degree of similarity to intermediate data D[m1] exceeds the threshold value, and the numerical value indicating that it does not correspond to a beat point (i.e., zero) is reduced.

As can be understood from the foregoing explanation, in the first embodiment, in addition to intermediate data D[m1] and intermediate data D[m2] directly related to the change instruction, intermediate data D[m] that are similar to intermediate data D[m1] or intermediate data D[m2] among the M pieces of intermediate data D[1]˜D[M] throughout the entire musical piece, are also used to update the estimation model 50. Therefore, even though the beat point(s) for which the user issues a change instruction are only a part of the beat points in the musical piece, the estimation model 50, following execution of the estimation model update process Sc, can generate M pieces of output data O[1]˜O[M] that reflect the change instruction throughout the entire musical piece. As discussed above, in the first embodiment, both intermediate data D[m1] and intermediate data D[m2] are used to update the estimation model 50. However, only one of intermediate data D[m1] and intermediate data D[m2] can be used to update the estimation model 50.

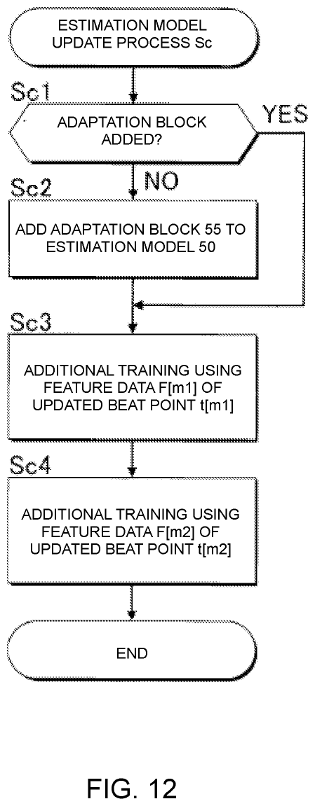

FIG. 12 is a flowchart illustrating the specific steps of the estimation model update process Sc. The control device 11 functions as the estimation model updating unit 27 to execute the estimation model update process Sc.

If the estimation model update process Sc is started, the estimation model updating unit 27 determines whether the adaptation block 55 has already been added to the estimation model 50 (Sc1). If the adaptation block 55 has not been added to the estimation model 50 (Sc1: NO), the estimation model updating unit 27 adds a new initial adaptation block 55 between the first part 50a and the second part 50b of the estimation model 50. On the other hand, if the adaptation block 55 has already been added in a previous estimation model update process Sc (Sc1: YES), the addition of the adaptation block 55 (Sc2) is not performed.

If a new adaptation block 55 is added, the estimation model 50 including the new adaptation block 55 is updated by the following process, and if the adaptation block 55 has already been added, the estimation model 50 including the existing adaptation block 55 is also updated by the following process. In other words, in a state in which the adaptation block 55 is added to the estimation model 50, the estimation model updating unit 27 performs additional training (Sc3 and Sc4) to which are applied the locations of beat points before and after the change according to the change instruction from the user, thereby updating the plurality of variables of the estimation model 50. If the user has issued an instruction to change the locations of two or more beat points, the additional training (Sc3 and Sc4) is performed for each beat point pertaining to the change instruction.

The estimation model updating unit 27 uses feature data F[m1] at analysis time point t[m1] where the beat point is located before the change according to the change instruction to update the plurality of variables of the estimation model 50 (Sc3). Specifically, the estimation model updating unit 27 sequentially supplies each of the M pieces of intermediate data D[1]˜D[M] to the adaptation block 55 in parallel with the supply of feature data F[m1] to the estimation model 50 and updates the plurality of variables of the estimation model 50 so that the probability P[m] of output data O[m] generated from each piece of intermediate data D[m] similar to intermediate data D[m1] of feature data F[m1] approaches zero. Thus, the estimation model 50 is trained to produce output data O[m] representing a probability P[m] close to zero when feature data F[m] similar to feature data F[m1] at the analysis time point t[m1] are input.

The estimation model updating unit 27 also updates the plurality of variables of the estimation model 50 using feature data F[m2] at analysis time point t[m2] where the beat point is located after the change according to the change instruction (Sc4). Specifically, the estimation model updating unit 27 sequentially supplies each of the M pieces of intermediate data D[1]˜D[M] to the adaptation block 55 in parallel with the supply of feature data F[m2] to the estimation model 50 and updates the plurality of variables of the estimation model 50 so that the probability P[m] of output data O[m] generated from each piece of intermediate data D[m] similar to intermediate data D[m2] of feature data F[m2] approaches 1. Therefore, the estimation model 50 is trained to generate output data O[m] representing a probability P[m] close to one when feature data F[m] similar to feature data F[m2] at analysis time point t[m2] are input.

In addition to the estimation model 50 being updated in accordance with a change instruction by the estimation model update process Sc as described above, in the first embodiment, the plurality of updated beat points are estimated by performing the beat point estimation process Sb under the constraint condition according to the change instruction.

As described above, of the five transition points Y[0]˜Y[4] in the beat interval δ, transition point Y[0] corresponds to a beat point and the remaining four transition points Y[1]˜Y[4] do not correspond to beat points. Analysis time point t[m2] on the time axis corresponds to a beat point after the change according to the change instruction. Therefore, from the N likelihoods λ[i, j] corresponding to different states Q at the analysis time point t[m2], the estimation processing unit 23 forcibly sets the likelihood λ[i, j′] corresponding to the transition point Y[j′] (j′=1˜4) other than the transition point Y[0] to zero. In addition, from the N likelihoods λ[i, j] at analysis time point t[m2], the estimation processing unit 23 maintains the likelihood λ[i, 0] corresponding to transition point Y[0] to a numerical value calculated by the method described above. Therefore, in the generation of the state series (Sb3), a maximum likelihood path that necessarily passes through the state Q of the transition point Y[0] at the analysis time point t[m2] is estimated. That is, the analysis time point t[m2] is estimated to correspond to a beat point. As can be understood from the foregoing explanation, the beat point estimation process Sb is performed under the constraint condition that the state Q of the transition point Y[0] is observed at the analysis time point t[m2] of the beat point after the change according to the change instruction from the user.

On the other hand, the analysis time point t[m1] on the time axis does not correspond to a beat point after the change according to the change instruction. Thus, from among the N likelihoods λ[i, j] corresponding to different states Q at the analysis time point t[m1], the estimation processing unit 23 forcibly sets the likelihood λ[i, 0] corresponding to the transition point Y[0] to zero. In addition, from the N likelihoods λ[i, j] at the analysis time point t[m1], the estimation processing unit 23 maintains the likelihood λ[i, j′] corresponding to the transition points Y[j′] other than the transition point Y[0] to a significant numerical value calculated by the method described above. Therefore, in the generation of the state series (Sb3), the maximum likelihood path that does not pass through the state Q of the transition point Y[0] at analysis time point t[m1] is estimated. That is, the analysis time point t[m1] is estimated not to correspond to a beat point. As can be understood from the foregoing explanation, the beat point estimation process Sb is executed under the constraint condition that the state Q of the transition point Y[0] is not observed at the analysis time point t[m1] before the change according to the change instruction from the user.

As described above, the likelihood λ[i, 0] of the transition point Y[0] at analysis time point t[m1] is set to zero, and the likelihood λ[i, j′] of the transition points Y[j′] other than the transition point Y[0] at analysis time point t[m2] is set to zero, thereby changing the maximum likelihood path throughout the entire musical piece. That is, even though the beat points for which the user instructs a change are only a part of the beat points in the musical piece, the change instruction is reflects the plurality of beat points throughout the entire musical piece.

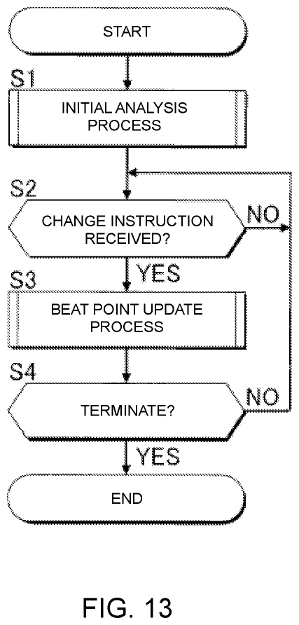

FIG. 13 is a flowchart illustrating the specific steps of a process executed by the control device 11. The process of FIG. 13 is initiated by a user instruction from the operation device 14, for example. When the process is started, the control device 11 executes a process (hereinafter referred to as “initial analysis process”) for estimating a plurality of beat points of a musical piece by analyzing the audio signal A (S1).

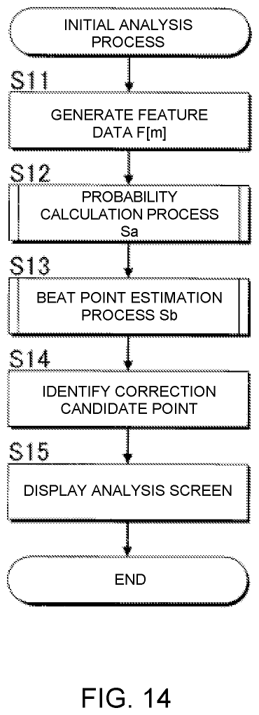

FIG. 14 is a flowchart illustrating the specific steps of the initial analysis process. When the initial analysis process is started, the control device 11 (as feature extraction unit 21) generates feature data F[m] for each of the M analysis time points t[1] t[M] on the time axis (S11). As described above, the feature data F[m] are a time series of a plurality of feature values f[m] in unit period U including analysis time point t[m].

The control device 11 (as probability calculation unit 22) executes the probability calculation process Sa illustrated in FIG. 6, thereby generating M pieces of output data O[m] corresponding to different analysis time points t[m] (S12). The control device 11 (estimation processing unit 23) also executes the beat point estimation process Sb illustrated in FIG. 9, thereby estimating a plurality of beat points in the musical piece (S13).

The control device 11 (as display control unit 24) identifies one or more correction candidate points among the plurality of beat points estimated by the beat point estimation process Sb (S14). Specifically, a beat point for which the beat interval δ between the beat point and the immediately preceding or immediately following beat point deviates from the average value in the musical piece, or a beat point for which the time length of the beat interval δ differs significantly from the time length(s) of a beat interval(s) δ before and/or after the beat interval δ, is identified as a correction candidate point. In addition, from the plurality of beat points, the beat point with a probability P[m] less than a prescribed value can be identified as a correction candidate point. The control device 11 (display control unit 24) causes the display device 13 to display the analysis screen 70 illustrated in FIG. 10 (S15).

When the initial analysis process illustrated above is executed, the control device 11 (as instruction receiving unit 26) waits until a change instruction from the user pertaining to a part of beat points from among the plurality of beat points in the musical piece is received, as is illustrated in FIG. 13 (S2: NO). When a change instruction is received (S2: YES), the control device 11 (as estimation model updating unit 27 and analysis processing unit 20) executes a beat point update process for updating the locations of the plurality of beat points estimated in the initial analysis process in accordance with the change instruction from the user (S3).

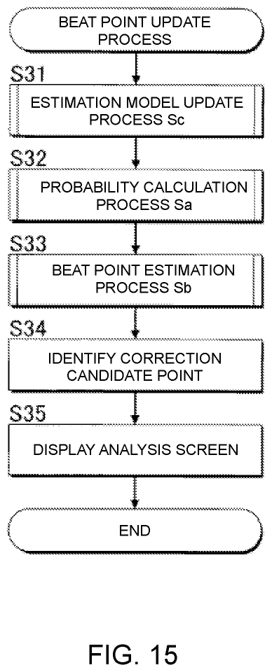

FIG. 15 is a flowchart illustrating the specific steps of the beat point update process. By executing the estimation model update process Sc illustrated in FIG. 12, the control device 11 (as estimation model updating unit 27) updates the plurality of variables of the estimation model 50 in accordance with the change instruction from the user (S31).

By using the estimation model 50 after the update by the estimation model update process Sc to execute the probability calculation process Sa of FIG. 6, the control device 11 (as probability calculation unit 22) generates M pieces of output data O[1]˜O[M] (S32). By executing the beat point estimation process Sb of FIG. 9, which uses the M pieces of output data O[1]-O[M], the control device 11 (as analysis processing unit 20) also generates beat point data B (S33). That is, a plurality of beat points in the musical piece are estimated. The beat point estimation process Sb in the beat point update process is executed under the above-mentioned constraint condition in accordance with the change instruction.

As can be understood from the foregoing explanation, a plurality of updated beat points are estimated by the estimation model update process Sc for updating the estimation model 50, the probability calculation process Sa that uses the updated estimation model 50, and the beat point estimation process Sb that uses the output data O[m] generated by the probability calculation process Sa. In other words, an element (beat point updating unit) that updates the locations of the estimated plurality of beat points is realized by the estimation model updating section 27, the probability calculation section 22, and the estimation processing unit 23.

The control device 11 (display control unit 24) identifies one or more correction candidate points from the plurality of beat points estimated by the beat point estimation process Sb (S34), in the same manner as in the above-mentioned Step S14. The control device 11 (display control unit 24) causes the display device 13 to display the analysis screen of FIG. 10 including the beat images 751 representing each of the updated beat points (S35).

When the beat point update process illustrated above is executed, the control device 11 determines whether the user has issued an instruction to terminate the process, as shown in FIG. 13 (S4). If there has been no instruction to terminate the process (S4: NO), the control device 11 shifts to waiting for a user change instruction (S2). The control device 11 executes the beat point updating process, initiated by another change instruction from the user (S3). In the estimation model updating process Sc (231) of the second and subsequent beat point updating processes, the determination (Sc1) regarding whether an adaptation block is present results in the affirmative, so that the addition of a new adaptation block 55 is not executed. That is, the estimation model 50 to which the adaptation block 55 is added in the first beat point update process is cumulatively updated for each subsequent execution of the estimation model updating process Sc. On the other hand, if there has been an instruction to terminate the process (S4: YES), the control device 11 ends the process of FIG. 13.

As described above, in the first embodiment, in accordance with a user change instruction pertaining to a part of the plurality of beat points estimated by analyzing the audio signal A, the locations of a plurality of beat points in the musical piece including beat points other than the aforesaid some beat points are updated. That is, the change instruction for a part of the musical piece is reflected on the entire musical piece. Therefore, compared to a configuration in which the user must issue an instruction to change the location of all of the beat points in the musical piece, a time series of beat points in accordance with the intentions of the user can be obtained, while reducing the burden on the user to issue instructions to change the location of each beat point.

With an adaptation block 55 added between the first part 50a and the second part of the estimation model 50, the estimation model 50 is updated by additional training that applies the locations of beat points before and after the change according to the change instruction from the user. Therefore, the estimation model 50 can be specialized in the estimated beat points are in accordance with the intentions or preferences of the user.

In addition, the state transition model 60 comprising a plurality of states Q corresponding to any of the plurality of tempos X[i] is used to estimate the plurality of beat points. Therefore, a plurality of beat points can be estimated so that the tempo X[i] transitions in a natural manner. Particularly, in the first embodiment, the plurality of states Q of the state transition model 60 correspond to different combinations of each of the plurality of tempos X[i] and each of the plurality of transition points Y[j] in the beat interval δ, and the beat point estimation process Sb is executed under the constraint condition that the state Q corresponding to transition point Y[0] is observed at analysis time point t[m] of the beat point after the change according to a change instruction from the user. Therefore, a plurality of beat points can be estimated that include time points after the change according to the change instruction from the user.

### B: Second Embodiment

The second embodiment will now be described. In each of the embodiments described below, elements that have the same functions as in the first embodiment have been assigned the same reference numerals as those used to describe the first embodiment and their detailed descriptions have been appropriately omitted.

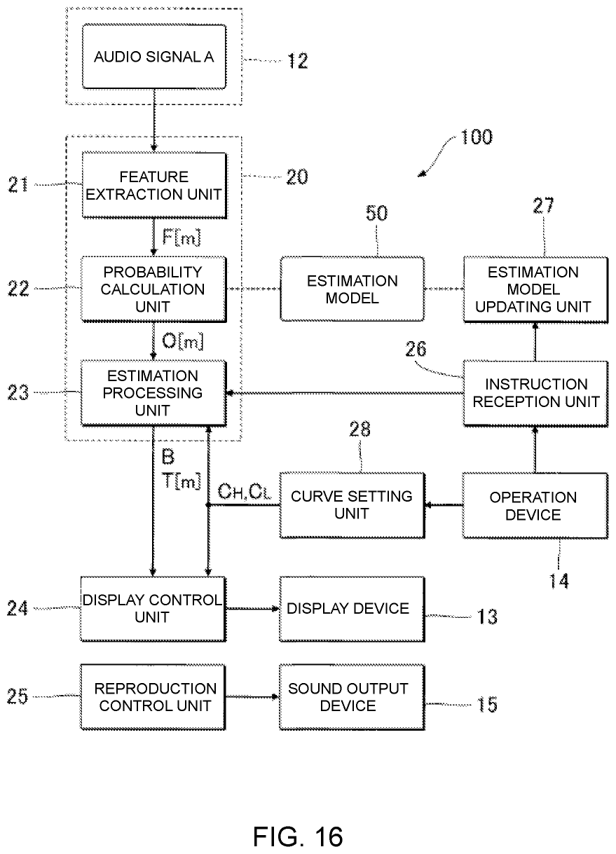

FIG. 16 is a block diagram illustrating the functional configuration of the audio analysis system 100 according to a second embodiment. The control device 11 of the second embodiment functions as a curve setting unit 28, in addition to the same elements as those in the first embodiment (analysis processing unit 20, display control unit 24, reproduction control unit 25, instruction receiving unit 26, and estimation model updating unit 27).

The analysis processing unit 20 of the second embodiment estimates the tempo T[m] of a musical piece in addition to estimating a plurality of beat points in the musical piece. That is, the analysis processing unit 20 analyzes the audio signal A to estimate a time series of M tempos T[1]˜T[M] corresponding to different analysis time points t[m] on the time axis.

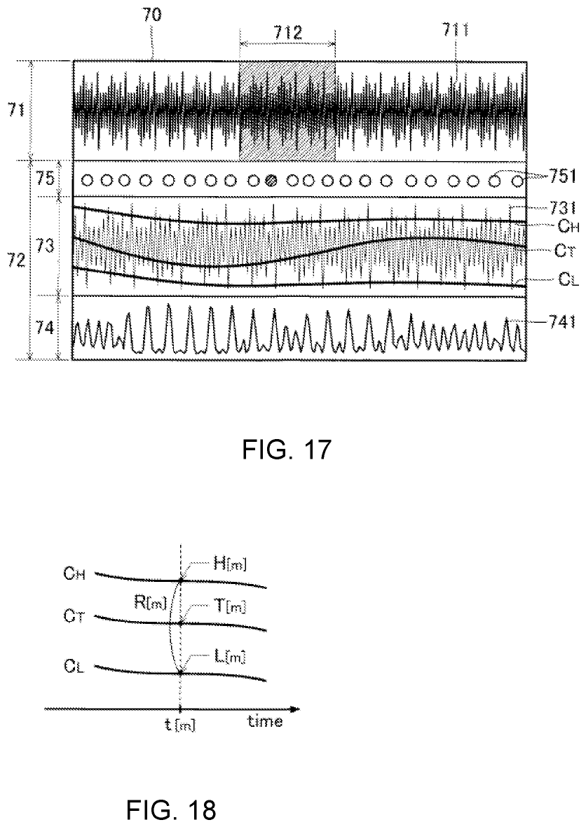

FIG. 17 is a schematized diagram of the analysis screen 70 according to the second embodiment. The analysis screen 70 of the second embodiment includes, in addition to the same elements as those in the first embodiment, estimated tempo curve CT, maximum tempo curve CH, and minimum tempo curve CL. Specifically, the waveform 731 of the audio signal A, estimated tempo curve CT, maximum tempo curve CH, and minimum tempo curve CL are displayed in the waveform region 73 of the analysis screen 70 on the same time axis. In FIG. 17, the display of the sound generation point 732 in the audio signal A has been omitted for the sake of convenience.

FIG. 18 is a schematized diagram showing estimated tempo curve CT, maximum tempo curve CH, and minimum tempo curve CL in isolation. The estimated tempo curve CT is a curve representing a time series of tempos T[m] estimated by the analysis processing unit 20. The maximum tempo curve CH is a curve representing the temporal change of the maximum value H[m] (maximum tempo value, hereinafter referred to as “maximum tempo”) of the tempos T[m] estimated by the analysis processing unit 20. That is, maximum tempo curve CH represents a time series of M maximum tempos H[1]˜H[M] corresponding to different analysis time points t[m] on the time axis. The minimum tempo curve CL is a curve representing the temporal change of the minimum value L[m] (minimum tempo value, hereinafter referred to as “minimum tempo”) of the tempos T[m] estimated by the analysis processing unit 20. That is, minimum tempo curve CL represents a time series of M minimum tempos L[1]˜L[M] corresponding to different analysis time points t[m] on the time axis.

As can be understood from the foregoing explanation, for each analysis time point t[m], the analysis processing unit 20 estimates tempo T[m] of the musical piece within a range R[m] (hereinafter referred to as the “restricted range”) between maximum tempo H[m] and minimum tempo L[m]. Therefore, the estimated tempo curve CT is located between maximum tempo curve CH and minimum tempo curve CL. The position and range width of restricted range R[m] changes with time.

The curve setting unit 28 of FIG. 16 sets maximum tempo curve CH and minimum tempo curve CL. For example, the user can operate the operation device 14 to indicate a maximum tempo curve CH of desired shape and a minimum tempo curve CL of desired shape. The curve setting unit 28 sets the maximum tempo curve CH and minimum tempo curve CL in accordance with an instruction from the user on the analysis screen 70 (waveform region 73). For example, the curve setting unit 28 sets the maximum tempo curve CH or minimum tempo curve CL as a continuous curve that passes through a plurality of points specified by the user in the waveform region 73 in chronological order. The user also can operate the operation device 14 to direct the waveform region 73 to change the maximum tempo curve CH and minimum tempo curve CL that have been set. The curve setting unit 28 changes the maximum tempo curve CH and minimum tempo curve CL in accordance with an instruction from the user for the analysis image (waveform region 73). As can be understood from the foregoing explanation, according to the second embodiment, the user can easily change the maximum tempo curve CH and minimum tempo curve CL while checking the analysis screen 70.

In the second embodiment, since the waveform 731 of the audio signal A and maximum tempo curve CH and minimum tempo curve CL are displayed on the same time axis, the user can easily visually ascertain the relationship between the waveform 731 of the audio signal A and the temporal change of maximum tempo H[m] or minimum tempo L[m]. In addition, since estimated tempo curve CT is displayed together with maximum tempo curve CH and minimum tempo curve CL, the user can visually ascertain the estimated temporal change of tempo T[m] of the musical piece between maximum tempo curve CH and minimum tempo curve CL.

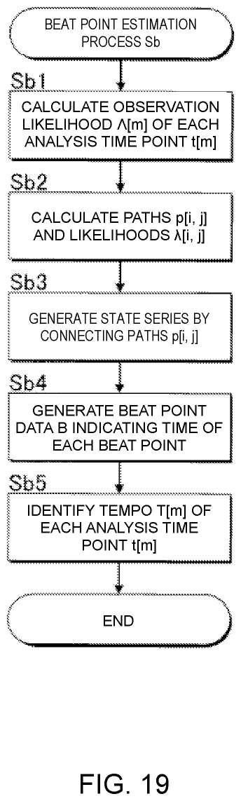

FIG. 19 is a flowchart illustrating the specific procedure of beat point estimation process Sb in the second embodiment. If the observation likelihood Λ[m] of each analysis time point t[m] is set in the same manner as in the first embodiment (Sb1), the estimation processing unit 23 calculates a path p[i, j] and likelihood λ[i, j] for each analysis time point t[m] with respect to each state Q [i, j] of the state transition model 60 (Sb2). For each analysis time point t[m], the estimation processing unit 23 of the second embodiment sets the likelihood λ[i, j] corresponding to each tempo X[i] that exceeds maximum tempo H[m] from the plurality of tempos X[i], and the likelihood λ[i, j] corresponding to each tempo X[i] that falls below the minimum tempo L[m] to zero. That is, of the N states Q of the state transition model 60, one or more states Q corresponding to the tempo X[i] outside of restricted range R[m] are set to an invalid state. Also, for each analysis time point t[m], the estimation processing unit 23 sets the likelihood λ[i, j] corresponding to each tempo X[i] inside of restricted range R[m] to a significant numerical value, in the same manner as in the first embodiment. That is, of the N states Q of the state transition model 60, one or more state Q corresponding to the tempo X[i] inside of restricted range R[m] are set to a valid state.

The estimation processing unit 23 generates a state series in the same way as in the first embodiment (Sb3). That is, from the N states Q, a series in which the states Q having high likelihoods λ[i, j] are arranged for each analysis time point t[m] is generated as the state series. As described above, the likelihood λ[i, j] of a state Q[i, j] corresponding to a tempo X[i] outside of the restricted range R[m] at the analysis time point t[m] is set to zero. Therefore, a state Q corresponding to a tempo X[i] outside of the restricted range R[m] is not selected as an element of the state series. As can be understood from the foregoing explanation, the invalid state of each state Q means that the state Q in question is not selected.

The estimation processing unit 23 generates beat point data B in the same manner as in the first embodiment (Sb4) and identifies the tempo T[m] of each analysis time point t[m] from the state series (Sb5). That is, the tempo X[i] of the state Q corresponding to analysis time point t[m] of the state series is set as the tempo T[m]. As described above, since a state Q corresponding to a tempo X[i] outside of the restricted range R[m] is not selected as an element of the state series, the tempo T[m] is limited to a numerical value inside of restricted range R[m].

As described above, in the second embodiment, maximum tempo curve CH and minimum tempo curve CL are set in accordance with an instruction from the user. The tempo T[m] of the musical piece is then estimated within the restricted range R[m] between maximum tempo H[m] represented by maximum tempo curve CH and minimum tempo L[m] represented by minimum tempo curve CL. Therefore, the possibility that a tempo that deviates excessively from the tempo intended by the user (for example, a tempo that is twice or half assumed by the user) is reduced. That is, tempo T[m] of the musical piece represented by the audio signal A can be estimated with high accuracy.

In addition, in the second embodiment, the state transition model 60 comprising a plurality of states Q corresponding to any of a plurality of tempos X[i] is used to estimate the plurality of beat points. Therefore, tempos T[m] that transition naturally over time are estimated. Moreover, tempos T[m] that are confined to the restricted range R[m] can be estimated by the simple process of setting the states Q of the plurality of states Q that correspond to tempos X[i] outside of the restricted range R[m] to invalid states.

### C: Third Embodiment

In the first embodiment, an example was used in which output data O[m] representing probability P[m] calculated by the probability calculation unit 22 by the estimation model 50 are applied to the beat point estimation process Sb executed by the estimation processing unit 23. In the third embodiment, probability P[m] calculated the estimation model 50 (hereinafter referred to as “probability P1[m]”) is adjusted in accordance with a user operation of the operation device 14, and the output data O[m] representing adjusted probability P2[m] are applied to the beat point estimation process Sb.

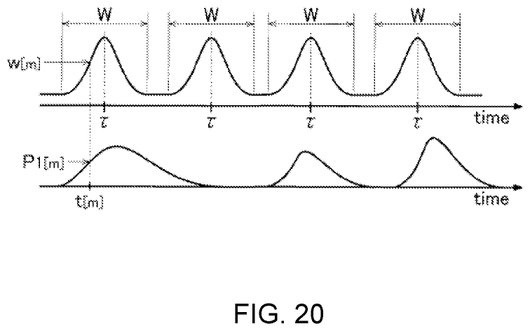

FIG. 20 is an explanatory diagram of a process in which the probability calculation unit 22 of the third embodiment generates output data O[m]. While listening to the performance sounds of a musical piece reproduced by the reproduction control unit 25 and output from the sound output device 15, the user operates the operation device 14 at each time point that the user recognizes as a beat point. For example, the user performs a tapping operation on the touch panel of the operation device 14 at time points that the user recognizes as beat points in parallel with the reproduction of the musical piece. In FIG. 20, the time points of the user operations (hereinafter referred to as “operation time points”) τ are shown on the time axis.

The probability calculation unit 22 sets a unit distribution W for each operation time point. The unit distribution W is the distribution of weighted values w[m] on the time axis. For example, a probability distribution in which the variance is set to a prescribed value, such as a normal distribution, is used as the unit distribution W. In each unit distribution W, weighted value w[m] is maximum at operation time points τ, and weighted value w[m] decreases with increasing distance from operation time point τ.

The probability calculation unit 22 multiplies probability P1[m] generated by the estimation model 50 with respect to the analysis time point t[m] by weighted value w[m] at the analysis time point t[m], thereby calculating adjusted probability P2[m]. Therefore, even for an analysis time point t[m] at which probability P1[m] generated by the estimation model 50 is small, if the analysis time point t[m] is close to operation time point τ, adjusted probability P2[m] is set to a large numerical value. The probability calculation unit 22 supplies output data O[m] representing adjusted probability P2[m] to the estimation processing unit 23. The procedure of the beat point estimation process Sb in which the estimation processing unit 23 uses output data O[m] to estimate a plurality of beat points is the same as that in the first embodiment.

The same effects as those of the first embodiment are realized by the third embodiment. In the third embodiment, since the weighted value w[m] of unit distribution W set at operation time point τ by the user is multiplied by probability P1[m], there is the advantage that the beat points can be estimated sufficiently to reflect the intentions or preference of the user. It is also possible to apply the configuration of the second embodiment to the third embodiment.

### D: Modified Example

Specific modified embodiments to be added to each of the aforementioned embodiment examples are illustrated below. Two or more embodiments arbitrarily selected from the following examples can be appropriately combined insofar as they are not mutually contradictory.
(1) The configuration of the estimation model 50 is not limited to the example shown in FIG. 4. For example, an implementation in which the estimation model 50 includes a recurrent neural network can also be assumed. Additional elements such as long short-term memory (LSTM) can also be incorporated into the estimation model 50. The estimation model 50 can be configured by a combination of a plurality of types of deep neural networks.
(2) The specific procedure of the process for estimating a plurality of beat points in the musical piece by analyzing the audio signal A is not limited to the examples of the embodiments described above. For example, the analysis processing unit 20 can estimate the analysis time point t[m] at which probability P[m] represented by output data O[m] reaches a local maximum as a beat point. In other words, the state transition model 60 is not used. In addition, the analysis processing unit 20 can estimate the time point at which a feature value f[m], such as the volume of the audio signal A, increases significantly as a beat point. In other words, the estimation model 50 is not used.
(3) The configuration of the first embodiment in which a plurality of beat points estimated by an initial analysis process are updated can be omitted in the second embodiment. That is, the configuration of the first embodiment in which a plurality of beat points throughout the entire musical piece are updated in accordance with a change instruction for some of the beat points of the plurality of beat points that have already been estimated, and the configuration of the second embodiment in which tempo T[m] of the musical piece is estimated within the restricted range R[m] in accordance with an instruction from the user can be realized independently of each other.
(4) For example, the audio analysis system 100 can be realized with a server device that communicates with information terminals, such as smartphones or tablet terminals. For example, the audio analysis system 100 generates beat point data B by analyzing the audio signal A received from an information device and transmits the beat point data B to the information device. Similarly, the receiving of user change instructions (S2) and the beat point updating process (S3) are also executed by the audio analysis system 100 that communicates with the information device.
(5) As described above, the functions of the audio analysis system 100 used as an example above are realized by cooperation between one or more processors that constitute the control device 11 and a program stored in the storage device 12. The program according to the present disclosure can be provided in a form stored on a computer-readable storage medium and installed on a computer. The storage medium is, for example, a non-transitory storage medium, a good example of which is an optical storage medium (optical disc) such as a CD-ROM, but can include storage media of any known form, such as a semiconductor storage medium or a magnetic storage medium. Non-transitory storage media include any storage medium that excludes transitory propagating signals and does not exclude volatile storage media. In addition, in a configuration in which a distribution device distributes the program via a communication network, a storage device 12 that stores the program in the distribution device corresponds to the non-transitory storage medium.

### E: Additional Statement

For example, the following configurations can be understood from the above-mentioned embodiments used as examples.
An audio analysis method according to one aspect (Aspect 1) of this disclosure comprises setting a maximum tempo curve representing the temporal change of a maximum value of tempo, and a minimum tempo curve representing the temporal change of a minimum value of tempo in accordance with an instruction from a user, and analyzing an audio signal representing the performance sound of a musical piece to estimate the tempo of the musical piece within a restricted range between the maximum value represented by the maximum tempo curve and the minimum value represented by the minimum tempo curve. In the aspect described above, the maximum tempo curve and the minimum tempo curve are set in accordance with an instruction from the user, and the tempo of a musical piece is estimated within the restricted range between the maximum value represented by the maximum tempo curve and the minimum value represented by the minimum tempo curve. Therefore, the possibility that the tempo will deviate excessively from the tempo assumed by the user (for example, a tempo that is twice or half the assumed tempo) is reduced. That is, the tempo of the musical piece represented by the audio signal can be estimated with high accuracy.
In a specific example (Aspect 2) of Aspect 1, an analysis screen that includes the maximum tempo curve and the minimum tempo curve is displayed on a display device, and in setting the maximum tempo curve and the minimum tempo curve, the maximum tempo curve and the minimum tempo curve are changed in accordance with the instruction from the user for the analysis screen. In the aspect described above, the user can easily change the maximum tempo curve and the minimum tempo curve while visually checking the analysis screen.
In a specific example (Aspect 3) of Aspect 2, the analysis screen is an image in which a waveform of the audio signal, the maximum tempo curve, and the minimum tempo curve are arranged on a common time axis. By the aspect described above, there is the advantage that it is easy for the user to visually ascertain the temporal relationship between the waveform of the audio signal and the temporal change of the maximum value of the tempo represented by the maximum tempo curve or the temporal change of the minimum value of the tempo represented by the minimum tempo curve.
In a specific example (Aspect 4) of Aspect 2 or 3, the analysis screen includes an estimated tempo curve representing the temporal change of a tempo estimated by an analysis of the audio signal. By the aspect described above, the user can visually ascertain the temporal change of the tempo of a musical piece estimated between the maximum tempo curve and the minimum tempo curve.
In a specific example (Aspect 5) of any one of Aspects 1 to 4, in estimating the tempo, a state transition model consisting of a plurality of states corresponding to any of a plurality of tempos is used to estimate the tempo of the musical piece, and a state corresponding to a tempo outside of the restricted range, from the plurality of states, is set to an invalid state. By the aspect described above, a plurality of beat points are estimated using a state transition model consisting of a plurality of states corresponding to any of a plurality of tempos. Therefore, a tempo that transitions naturally over time is estimated. Moreover, a tempo that is confined to the restricted range can be estimated by the simple process of setting, from a plurality of states, the state corresponding to a tempo outside of the restricted range to an invalid state.
An audio analysis system according to one aspect (Aspect 6) of this disclosure comprises a curve setting unit for setting a maximum tempo curve representing the temporal change of a maximum value of tempo and a minimum tempo curve representing the temporal change of a minimum value of tempo in accordance with an instruction from a user, and an analysis processing unit for analyzing an audio signal representing the performance sound of a musical piece to estimate the tempo of the musical piece within a restricted range between a maximum value represented by the maximum tempo curve and a minimum value represented by the minimum tempo curve.
A program according to one aspect (Aspect 7) of this disclosure causes a computer system to function as a curve setting unit for setting a maximum tempo curve representing the temporal change of a maximum value of tempo and a minimum tempo curve representing the temporal change of a minimum value of tempo in accordance with an instruction from a user, and an analysis processing unit for analyzing an audio signal representing the performance sound of a musical piece to estimate the tempo of the musical piece within a restricted range between a maximum value represented by the maximum tempo curve and a minimum value represented by the minimum tempo curve.

“Tempo” in this Specification is an arbitrary numerical value representing the speed of the performance and is not limited to tempo in the narrow sense, meaning the number of beats per unit time (BPM: Beats Per Minute).

By the audio analysis method, audio analysis system, and program of this disclosure, the tempo of the musical piece represented by the audio signal can be estimated with high accuracy.

What is claimed is:

1. An audio analysis method realized by a computer system, the audio analysis method comprising:
setting a maximum tempo curve representing a temporal change of a maximum tempo value and a minimum tempo curve representing a temporal change of a minimum tempo value in accordance with an instruction from a user; and
analyzing an audio signal representing a performance sound of a musical piece, thereby estimating a tempo of the musical piece within a restricted range between a maximum value represented by the maximum tempo curve and a minimum value represented by the minimum tempo curve.

2. The audio analysis method according to claim 1, further comprising
displaying on a display an analysis screen including the maximum tempo curve and the minimum tempo curve, wherein
in the setting of the maximum tempo curve and the minimum tempo curve, the maximum tempo curve and the minimum tempo curve are changed in accordance with the instruction from the user on the analysis screen.

3. The audio analysis method according to claim 2, wherein
the displaying of the analysis screen is performed such that, as the analysis screen, an image in which a waveform of the audio signal, the maximum tempo curve, and the minimum tempo curve are arranged on a common time axis is displayed.

4. The performance analysis method according to claim 2, wherein
the displaying of the analysis screen is performed such that the analysis screen further includes an estimated tempo curve representing a temporal change of the tempo estimated by the analyzing of the audio signal.

5. The audio analysis method according to claim 1, wherein
the estimating of the tempo is performed by using a state transition model including a plurality of states corresponding to any one of a plurality of tempos, and by setting, to an invalid state, a state corresponding to an outside tempo outside of the restricted range, from among the plurality of states.

6. An audio analysis system comprising:
an electronic controller including at least one processor, the electronic controller being configured to execute
a curve setting unit configured to set a maximum tempo curve representing a temporal change of a maximum tempo value and a minimum tempo curve representing a temporal change of a minimum tempo value in accordance with an instruction from a user, and
an analysis processing unit configured to analyze an audio signal representing a performance sound of a musical piece, and thereby estimate a tempo of the musical piece within a restricted range between a maximum value represented by the maximum tempo curve and a minimum value represented by the minimum tempo curve.

7. The audio analysis system according to claim 6, wherein
the electronic controller is further configured to execute a display control unit configured to cause a display to display an analysis screen including the maximum tempo curve and the minimum tempo curve, and
the curve setting unit is configured to change the maximum tempo curve and the minimum tempo curve in accordance with the instruction from the user on the analysis screen, to set the maximum tempo curve and the minimum tempo curve.

8. The audio analysis system according to claim 7, wherein
the analysis screen is an image in which a waveform of the audio signal, the maximum tempo curve, and the minimum tempo curve are arranged on a common time axis.

9. The audio analysis system according to claim 7, wherein
the analysis screen further includes an estimated tempo curve representing a temporal change of the tempo estimated by the analysis processing unit.

10. The audio analysis method according to claim 6, wherein
the analysis processing unit is configured to use a state transition model including a plurality of states corresponding to any one of a plurality of tempos to estimate the tempo of the musical piece, and is configured to set, to an invalid state, a state corresponding to an outside tempo outside of the restricted range, from among the plurality of states.

11. A non-transitory computer-readable medium storing a program that causes a computer system to execute a process, the process comprising:
setting a maximum tempo curve representing a temporal change of a maximum tempo value and a minimum tempo curve representing a temporal change of a minimum tempo value in accordance with an instruction from a user; and
analyzing an audio signal representing a performance sound of a musical piece, thereby estimating a tempo of the musical piece within a restricted range between a maximum value represented by the maximum tempo curve and a minimum value represented by the minimum tempo curve.

12. The non-transitory computer-readable medium according to claim 11, wherein
the process further comprises displaying on a display an analysis screen including the maximum tempo curve and the minimum tempo curve, and
in the setting of the maximum tempo curve and the minimum tempo curve, the maximum tempo curve and the minimum tempo curve are changed in accordance with the instruction from the user on the analysis screen.

13. The non-transitory computer-readable medium according to claim 12, wherein
the displaying of the analysis screen is performed such that, as the analysis screen, an image in which a waveform of the audio signal, the maximum tempo curve, and the minimum tempo curve are arranged on a common time axis is displayed.

14. The non-transitory computer-readable medium according to claim 12, wherein
the displaying of the analysis screen is performed such that the analysis screen further includes an estimated tempo curve representing a temporal change of the tempo estimated by the analyzing of the audio signal.

15. The non-transitory computer-readable medium according to claim 11, wherein
the estimating of the tempo is performed by using a state transition model including a plurality of states corresponding to any one of a plurality of tempos, and by setting, to an invalid state, a state corresponding to an outside tempo outside of the restricted range, from among the plurality of states.
